(19) United States
(12) Patent Application Publication
(10) Pub. No.: US 2008/0143606 A1
(43) Pub. Date: Jun. 19, 2008

(54) ANTENNA ASSEMBLY AND COMMUNICATIONS ASSEMBLY

(75) Inventors: GUAN HONG NG, SINGAPORE (SG); TAY YEW SIOW, SINGAPORE (SG)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/611,966

(22) Filed: Dec. 18, 2006

(51) Int. Cl. H01Q 1/38; H01Q 9/04

(52) U.S. Cl. 343/700 MS

(57) ABSTRACT

An antenna radiator assembly (201) and radio communications assembly (200) comprising a circuit board (210) supporting electrical conductors (225). A ground plane (140) is supported by the circuit board (210) and a symmetrical antenna radiator element (107) is coupled to a feed point (130). When viewed in plan view, a first surface area of the symmetrical antenna radiator element (107) overlaps part of the ground plane (140). There is a ground connector (131) inductively coupling the symmetrical antenna radiator element to the ground plane (141). There are two identical parasitic ground coupling plates (142,143) that when viewed in the plan view overlap respective secondary surface areas of the symmetrical antenna radiator element (107). Switching circuitry (160) provides selectively coupling the two identical parasitic ground coupling plates (142,143) to the ground plane (140). When viewed in the plan view the symmetrical antenna radiator element (107) and the two identical parasitic ground coupling plates (142,143) are symmetrical about a central axis (A).

### FIELD OF THE INVENTION

This invention relates to an antenna assembly and radio communications assembly including an antenna assembly. The invention is particularly useful for, but not necessarily limited to, multi-band wireless communication devices with internal antennas.

### BACKGROUND ART OF THE INVENTION

Wireless communication devices often require multi-band antennas for transmitting and receiving radio communication signals often called Radio Frequency (RF) signals. For example, network operators provide services on a GSM system in a 900 MHz frequency band typically used in Asia also use a DCS system in a 1800 MHz frequency band typically used in Europe. Accordingly, GSM wireless communication devices, such as cellular radio telephones, should have dual band antennas to be able to effectively communicate at least at both of these frequencies. Also, in certain countries service providers operate on 850 MHz or 1900 MHz frequency bands. Accordingly, GSM wireless communication devices, such as cellular radio telephones, should have multi band antennas to be able to effectively communicate on more than one of these frequency bands.

Current consumer requirements are for compact wireless communication devices that typically have an internal antenna radiator structure instead of an antenna stub that is visible to the user. There has also been a recent trend towards thin form factor cellular telephones. These thin form factor cellular telephones require a miniaturized antenna radiator structure comprising an antenna radiator structure coupled to a ground plane, the ground planes being typically formed on or in a circuit board of the telephone. Further, these internal antenna radiator structures (patch antennas), such as a Planar Inverted F Antenna (PIFA) or Planar Inverted L Antenna (PILA), that use a radiator element in the form of a micro-strip internal patch antenna, are considered advantageous in several ways because of their compact lightweight structure, which is relatively easy to fabricate and produce with precise printed circuit techniques capable of integration on printed circuit boards.

Internal antenna radiator structures are typically installed inside a cellular phone where congested electronic components are placed nearby. In order for such internal antenna radiator structures to allow for thin or compact form factors, these antenna radiator structures must be compact and their bandwidth and gain should not be unduly affected by the relatively close proximity of the electronic components.

### BRIEF DESCRIPTION OF THE DRAWINGS

In order that the invention may be readily understood and put into practical effect, reference now will be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a schematic block diagram of a radio communications device in accordance with the present invention;

FIG. 2 is perspective view of a radio communications assembly including an antenna radiator assembly of a first embodiment in accordance with the invention; and

FIG. 3 is a plan view of part of part of a radio communications assembly that includes the antenna radiator assembly of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations apparatus components related to radio communications assemblies and antenna radiator assemblies. Accordingly, the assembly components have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

In this document, relational terms such as left and right, first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a radio communications assembly and antenna radiator assembly that comprises a list of elements does not include only those elements but may include other elements not expressly listed or inherent to such radio communications assemblies and antenna radiator assemblies. An element preceded by “comprises a . . . ” does not, without more constraints, preclude the existence of additional identical elements in the radio communications assembly and antenna radiator assembly.

According to one aspect of the present invention there is provided an antenna radiator assembly comprising a circuit board supporting electrical conductors, at least one of the electrical conductors being coupled to a feed point. A ground plane is supported by the circuit board and a symmetrical antenna radiator element is coupled to the feed point. The symmetrical antenna radiator element is spaced from the ground plane and when viewed in plan view a first surface area of the symmetrical antenna radiator element overlaps part of the ground plane. There is a ground connector inductively coupling the symmetrical antenna radiator element to the ground plane and the assembly has at least two identical parasitic ground coupling plates that when viewed in the plan view overlap respective secondary surface areas of the symmetrical antenna radiator element. Switching circuitry selectively couples the two identical parasitic ground coupling plates to the ground plane, wherein when viewed in the plan view the symmetrical antenna radiator element and the two identical parasitic ground coupling plates are symmetrical about a central axis.

According to another aspect of the present invention there is provided a circuit board supporting electrical conductors, at least one of the electrical conductors being coupled to a feed point and the feed point being coupled to radio frequency communications circuitry supported mounted on the circuit board. A ground plane is supported by the circuit board and a symmetrical antenna radiator element is coupled to the feed point. The symmetrical antenna radiator element is spaced from the ground plane and when viewed in plan view a first surface area of the symmetrical antenna radiator element overlaps part of the ground plane. There is a ground connector inductively coupling the symmetrical antenna radiator element to the ground plane and the assembly has at least two identical parasitic ground coupling plates that when viewed in the plan view overlap respective secondary surface areas of the symmetrical antenna radiator element. Switching circuitry selectively couples the two identical parasitic ground coupling plates to the ground plane, wherein when viewed in the plan view the symmetrical antenna radiator element and the two identical parasitic ground coupling plates are symmetrical about a central axis.

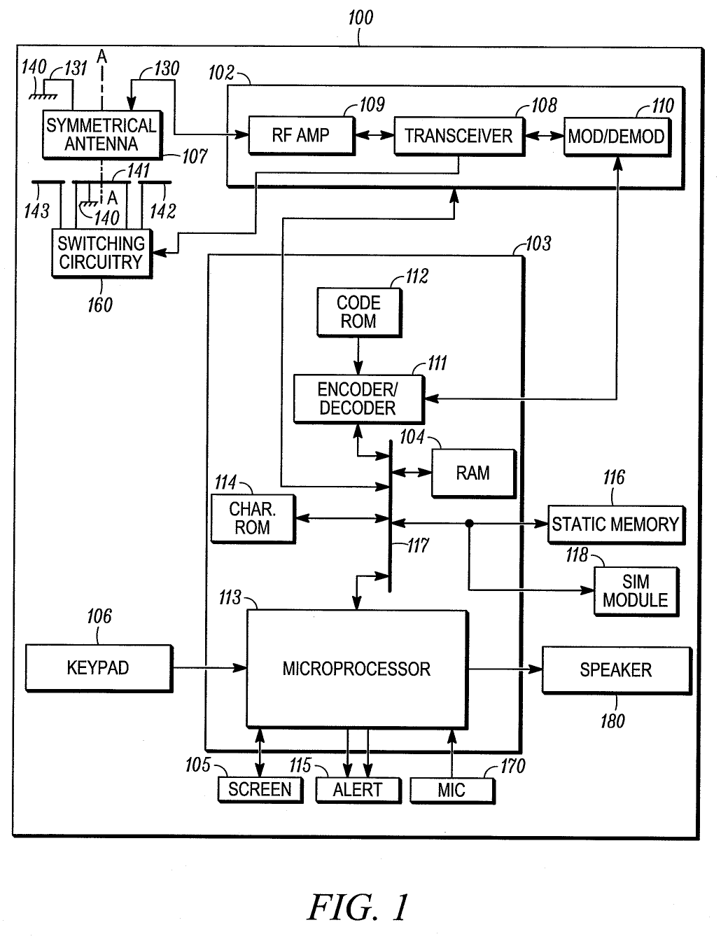

With reference to FIG. 1, there is illustrated a radio communications device in the form of a radio telephone 100 comprising radio frequency communications circuitry 102 coupled to be in communication with a processor 103. An input interface in the form of a screen 105 and a keypad 106 are also coupled to be in communication with the processor 103. As will be apparent to a person skilled in the art the screen 105 can be a touch screen thereby eliminating the need for the keypad 106.

The processor 103 includes an encoder/decoder 111 with an associated Code Read Only Memory (ROM) 112 storing data for encoding and decoding voice or other signals that may be transmitted or received by the radio telephone 100. The processor 103 also includes a micro-processor 113 coupled, by a common control, data and address bus 117, to the radio frequency communications circuitry 102, encoder/decoder 111, a character Read Only Memory (ROM) 114, a Random Access Memory (RAM) 104, static programmable memory 116 and a Subscriber Identity Module (SIM) interface 118 for operatively coupling with a removable SIM card. The static programmable memory 116 and a SIM card when operatively coupled to the SIM interface 118 each can store, amongst other things, selected incoming text messages and a telephone book database.

The micro-processor 113 has ports for coupling to the keypad 106, the screen 105, a speaker 180, a microphone 170 and an alert module 115 that typically contains a speaker, vibrator motor and associated drivers. The character Read only memory 114 stores code for decoding or encoding text messages that may be received by the radio frequency communication circuitry 102, input at the keypad 106. In this embodiment the character Read Only Memory 114 also stores operating code (OC) for micro-processor 113. As will be apparent to a person skilled in the art the radio telephone 100 also has and other components that are not illustrated.

The radio frequency communications circuitry 102 is has a transceiver 108 coupled to both a radio frequency amplifier 109 and a combined modulator/demodulator 110. There is also illustrated a symmetrical antenna radiator element 107 that is directly coupled to the radio frequency amplifier 109 by a feed point 130. Thus, the feed point 130 provides for electrically coupling a symmetrical antenna radiator element 107 to the radio frequency communications circuitry 102. A ground connector 131 provides for inductively coupling the symmetrical antenna radiator element 107 to a ground plane 140.

The ground plane 140 includes a conductive planar sheet 141 and there is switching circuitry 160 coupled to, and controllable by, the transceiver 108. The switching circuitry 160 has switching terminals for selectively electrically coupling two identical parasitic ground coupling plates 142,143 to the ground plane 140.

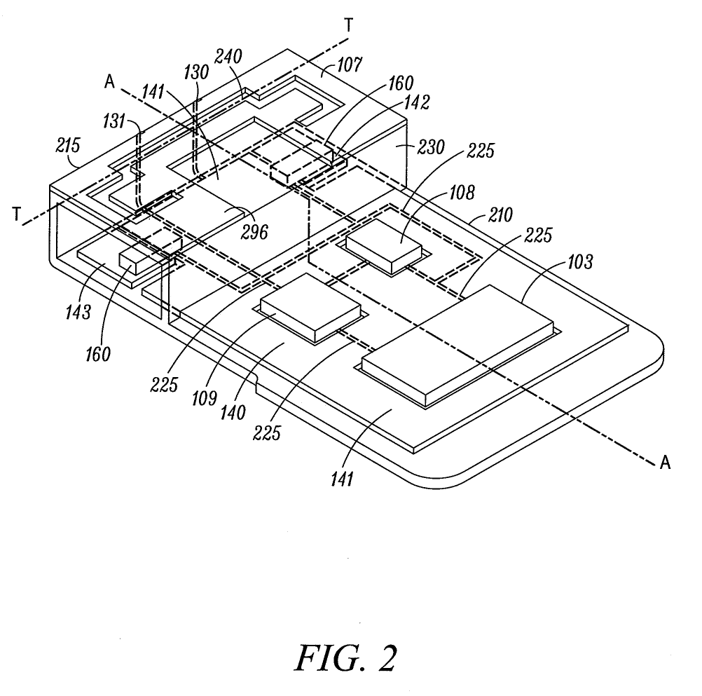

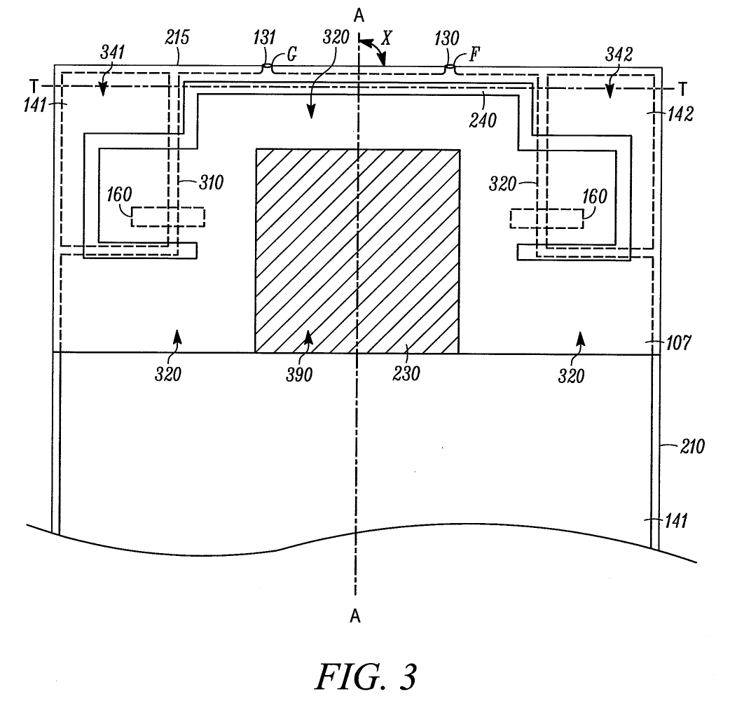

Referring to FIGS. 2 and 3 there is illustrated one preferred embodiment of a radio communications assembly 200 including an antenna radiator assembly 201 forming part of the radio telephone 100. The radio communications assembly 200 comprises a circuit board 210 supporting electrical conductors 225 that are typically sandwiched inside the layers of the circuit board 210. The circuit board 210 provides a base for supporting the radio frequency amplifier 109, the transceiver 108, the processor 103 and the switching circuitry 160. There is also shown the conductive planar sheet 141 supported by (mounted to or formed on) the circuit board 210, this conductive planar sheet 141 provides at least part of the ground plane 140. For instance, there may be also other typical components/modules (not shown for clarity) and other conductive sheets may be provided and combined forming the ground plane 140 that are mounted to or electrically coupled the circuit board 210.

The symmetrical antenna radiator element 107 is mounted to a dielectric mount 230 (typically formed from a thermoplastics material) that spaces the symmetrical antenna radiator element 107 from the ground plane 140. When viewed in plan view a first surface area 320 of the symmetrical antenna radiator element 107 overlaps part of the conductive planar sheet 141 forming the ground plane 140.

The symmetrical antenna radiator element 107 is a patch antenna and comprises a flat sheet having a surface area 296 is parallel with the conductive planar sheet 141. The antenna radiator assembly 201 includes the two identical parasitic ground coupling plates 142,143 that when viewed in the plan view overlap respective secondary surface areas 341,342 of the symmetrical antenna radiator element 107. Also, when viewed in the plan view the symmetrical antenna radiator element 107 and the two identical parasitic ground coupling plates 142,143 are symmetrical about a central axis A.

The two identical parasitic ground coupling plates 141,142 are planar members supported by the circuit board 210, and these planar members are coplanar with the conductive planar sheet 141. Also, these the planar members are disposed adjacent edges 310, 320 of the conductive planar sheet 141 and the switching circuitry 160 is mounted to the conductive planar sheet 141. In use, the switching circuitry provides for selectively electrically coupling the two identical parasitic ground coupling plates 141,142 to the ground plane 140.

The symmetrical antenna radiator element 107 is coupled to the frequency communications circuitry 102, specifically the transceiver 108 through: a) the feed point 130, that contacts (is coupled to) the symmetrical antenna radiator element 107 at a point F; b) the radio frequency amplifier 109; and c) some of the electrical conductors or runners 225 coupled to the feed point 130 (most runners on circuit board 210 are not shown). Also, the ground connector 131 is coupled to the ground plane 140 and is coupled to (contacts) the symmetrical antenna radiator element 107 at a point G.

The ground connector 131 and the feed point 130 couple the symmetrical antenna radiator element 107 at a common edge 215 of the symmetrical antenna radiator element 107, the common edge 215 being normal (at a right angle as shown by angle X) to the central axis A. More specifically, when viewed in the plan view the ground connector 131 and the feed point 130 are disposed at equal distances from the central axis L so that point G and point F are equidistant from the central axis L.

As illustrated, there is a slot 240 in the symmetrical antenna radiator element 107, the slot 240 has a length with a transverse axis T that is normal to (at a right angle to) the central axis A. When viewed in plan view, slot 240 overlaps both of the parasitic ground coupling plates 142,143. The symmetrical antenna radiator element 107 also has a recess identified by a shaded area 390 directly below which there can be mounted, to the circuit board, 210, electronic components (EC).

Advantageously, the present invention provides for compact, economic multi-band internal antenna radiator assembly 201 and a radio communications assembly 200 capable of operating at multiple specified bands. In use, the present invention can operate at the 1900 MHz and 900 MHz bands and when the switching unit 160 electrically couples the ground coupling plates 141,142 to the ground plane 140 loading occurs and the frequency bands are modified (switched) to 1800 MHz and 850 MHz respectively. Further, it may be possible to have some of the electronic components (EC) mounted to the circuit board 210 under the shaded area 390. The close proximity of these electronic components (EC) to the symmetrical antenna radiator element 107 should not be unduly affect its bandwidth and gain.

The detailed description provides preferred exemplary embodiments only, and is not intended to limit the scope, applicability, or configuration of the invention. Rather, the detailed description of the preferred exemplary embodiments provide those skilled in the art with an enabling description only. It should be understood that various changes may be made in the function and arrangement of elements without departing from the spirit and scope of the invention as set forth in the appended claims.

We claim:

1. An antenna radiator assembly comprising:
a circuit board supporting electrical conductors, at least one of the electrical conductors being coupled to a feed point;
a ground plane supported by the circuit board;
a symmetrical antenna radiator element coupled to the feed point, the symmetrical antenna radiator element being spaced from the ground plane and when viewed in plan view a first surface area of the symmetrical antenna radiator element overlaps part of the ground plane; and
a ground connector inductively coupling the symmetrical antenna radiator element to the ground plane;
at least two identical parasitic ground coupling plates that when viewed in the plan view overlap respective secondary surface areas of the symmetrical antenna radiator element;
switching circuitry selectively coupling the two identical parasitic ground coupling plates to the ground plane, wherein when viewed in the plan view the symmetrical antenna radiator element and the two identical parasitic ground coupling plates are symmetrical about a central axis.

2. An antenna radiator assembly as claimed in claim 1, wherein when viewed in the plan view the ground connector and feed point are disposed at equal distances from the central axis.

3. An antenna radiator assembly as claimed in claim 1, wherein the antenna radiator element is a patch antenna.

4. An antenna radiator assembly as claimed in claim 1, wherein the symmetrical antenna radiator element comprises a flat sheet.

5. An antenna radiator assembly as claimed in claim 1, wherein ground plane includes a planar sheet.

6. An antenna radiator assembly as claimed in claim 1, wherein a surface area of the antenna radiator element is parallel with the planar sheet.

7. An antenna radiator assembly as claimed in claim 1, wherein the two identical parasitic ground coupling plates are planar members supported by the circuit board, the planar members being coplanar with the planar sheet.

8. An antenna radiator assembly as claimed in claim 7, wherein the planar members are disposed adjacent edges of the planar sheet.

9. An antenna radiator assembly as claimed in claim 5, wherein the switching circuitry is mounted to the planar sheet.

10. An antenna radiator assembly as claimed in claim 1, wherein the ground connector and feed point couple the symmetrical antenna radiator element at a common edge of the symmetrical antenna radiator element.

11. An antenna radiator assembly as claimed in claim 10, wherein the common edge is normal to the central axis.

12. An antenna radiator assembly as claimed in claim 1, wherein there is at least one slot in the symmetrical antenna radiator element, wherein the slot has a length with an transverse axis that is normal to the central axis.

13. An antenna radiator assembly as claimed in claim 12, wherein when viewed in plan view the slot overlaps both of the parasitic ground coupling plates

14. A radio communications assembly comprising:
a circuit board supporting electrical conductors, at least one of the electrical conductors being coupled to a feed point and the feed point being coupled to radio frequency communications circuitry supported mounted on the circuit board;
a ground plane supported by the circuit board;
a symmetrical antenna radiator element coupled the feed point, the symmetrical antenna radiator element being spaced from the ground plane and when viewed in plan view a first surface area of the symmetrical antenna radiator element overlaps part of the ground plane; and
a ground connector inductively coupling the antenna radiator element to the ground plane;
at least two identical parasitic ground coupling plates that when viewed in the plan view overlap respective secondary surface areas of the symmetrical antenna radiator element;
switching circuitry selectively coupling the two identical parasitic ground coupling plates to the ground plane, wherein when viewed in the plan view the symmetrical antenna radiator element and the two identical parasitic ground coupling plates are symmetrical about a central axis.

15. A radio communications assembly as claimed in claim 14, wherein when viewed in the plan view the ground connector and feed point are disposed at equal distances from the central axis.

16. A radio communications assembly as claimed in claim 14, wherein the antenna radiator element comprises a flat sheet.

17. A radio communications assembly as claimed in claim 14, wherein ground plane includes a planar sheet.

18. A radio communications assembly as claimed in claim 14, wherein the ground connector and feed point couple the symmetrical antenna radiator element at a common edge of the symmetrical antenna radiator element.

19. A radio communications assembly as claimed in claim 18, wherein the common edge is normal to the central axis.

20. A radio communications assembly as claimed in claim 14, wherein there is at least one slot in the symmetrical antenna radiator element, wherein the slot has a length with an transverse axis that is normal to the central axis.

21. A radio communications assembly as claimed in claim 20, wherein when viewed in plan view the slot overlaps both of the parasitic ground coupling plates.
